(19) United States
(12) Patent Application Publication
(10) Pub. No.: US 2003/0145887 A1
(43) Pub. Date: Aug. 7, 2003

(54) Airless oil header

(76) Inventor: Wuu-Cheau Jou, Da Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/061,106

(22) Filed: Feb. 1, 2002

(51) Int. Cl. B67C 3/16

(52) U.S. Cl. 137/205

(57) ABSTRACT

The present invention relates to relates an airless oil header, and more especially to an oil airless sucking machine that has feathers of control easy and smaller volume for carryover, and can suit to any size oil container. The present invention has a three-way T-shaped nozzle carrier, which has a radial valve through-hole built as a valve buckle for a control valve cock fitting in so as to construct a control valve, a non-home switch handle snaps on the long tenons of said valve cock for spinning together, and by means of the friction force between a couple of O-rings located approaching the both ends of said valve cock and said valve buckle, said non-home switch can be kept in any position as turning for cut-in or off processes without needing to be held all the time during running. On the other hand, by the design of the dividable joint structure of said cap and the nozzle carrier, it makes change different size oil tanks for suiting to working on different gear box become true and easy and facility.

### BACKGROUND OF THE INVENTION

1. Field of the Invention

The present invention relates to an airless oil header, and more especially to an oil airless sucking machine that has smaller volume for carryover, and can suit to any size oil container, and has a non-home switch without needing to be held all the time as running.

2. Description of Prior Art

In common vehicles, trams, trains and various machines and mechanical equipments, the gear boxes need to use lubricant for lubrication, but after a certain period of running or running a certain mount of distance (km or mile), for keeping the lubrication function in efficient state the lubricant has to be replaced in time, in this case, in general, the users should use a professional oil header driven by a vacuum-pump generating vacuum sucking force to suck up waste oil. But this kind of oil header is very expensive, hence an airless oil header employing a vacuum suction force created by compressed air jet flow came out, as shown in FIG. 2, the conventional airless oil header 10 comprised of a blowgun 11, a nozzle carrier 12 combined on the blowpipe 111, a oil tank 13 attached on the bottom side of said nozzle carrier 12 via a cap 14 so that the vacuum suction force generated by compressed air jet flow blown out from a nozzle 121 in the inside of the nozzle carrier 12 at the high speed creates a suction force in said oil collection tank 13, and a suction pipe 15 crossing the inside of the gear box over the oil collection tank 13, because the specific weight of the oil is bigger than the air's, so the waste oil will be dropped into the oil collection tank 13, meanwhile the air is absorbed into the inside of said nozzle carrier 12, and winded out via a muffle 16 by high speed jet flow of compressed air with lower noise decreased, thereby keeping collection waste oil of said gear box into said oil collection tank 13 by suction until it is filled up and taken away for turning over.

Above-mentioned airless oil header, by means of the vacuum suction force generated by high speed jet flow of compressed air, has great suction effect in practice, whatever regarding structure and cost comparing with said pump oil header, it is bound to suit to apply in various factories and common families, but there are some demerits existing in structure design and facility as following:

1. During suction process the operator has to hold the lever latch 112 of said blowgun 11 down for keeping the compressed air jet flow on blowing state, so one hand is occupied by this, but in processing said suction pipe 15 has to be held for adjusting the position along with the change of the level of oil in the gear box, therefore the operator will feel inconvenience in this case.

2. Said nozzle carrier 12 and said cap 14 is fixed into an integrated structure in design, so said cap 14 can not be replaced so that the size of the oil tank is limited for joint, but not replaced different size of oil tank, especially applying in sucking large volume of oil, the operator has to interrupt the suction process to turn over the waste oil as the oil tank 13 is filled up, depending on the volume of oil contained in the gear box, the number of interruption is changed, so as to waste time and labor.

### OBJECTS AND SUMMARY OF THE INVENTION

It is therefore a main object of the present invention to provide an airless oil header, which can be operated easily, just need one action—cut in or off the non-home switch to control the compressed air jet flow.

Another object of the present invention is to provide an airless oil header suiting to variety of different size of oil containers for replacing.

### BRIEF DESCRIPTION OF THE DRAWINGS

FIG. 1 is a side view of a conventional airless oil header.

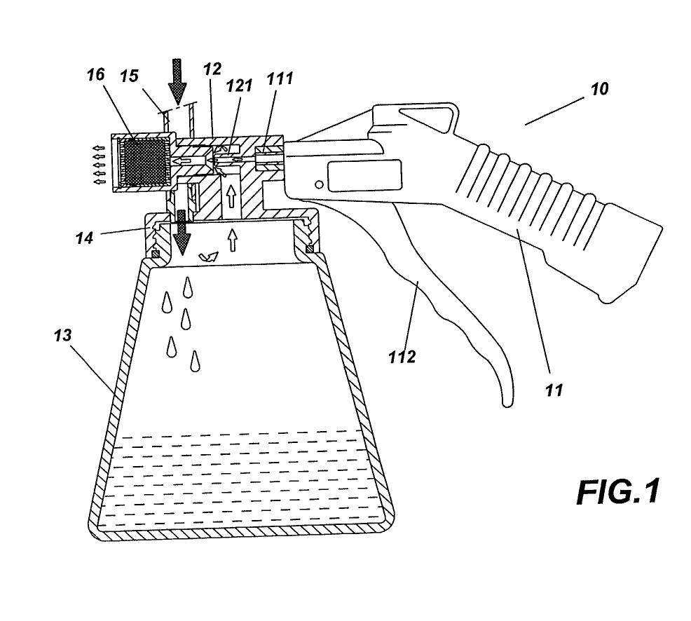

FIG. 2 is an exploded view of a present invention.

FIG. 3 is a cross-section view of the present invention.

FIG. 4 is a cross-section view showing the non-home switch placed and located in cut-in state of the present invention.

FIG. 5 is a cross-section view showing the joint with a changeable oil tank of the present invention.

### DETAILED DESCRIPTION OF PREFERRED EMBODIMENTS

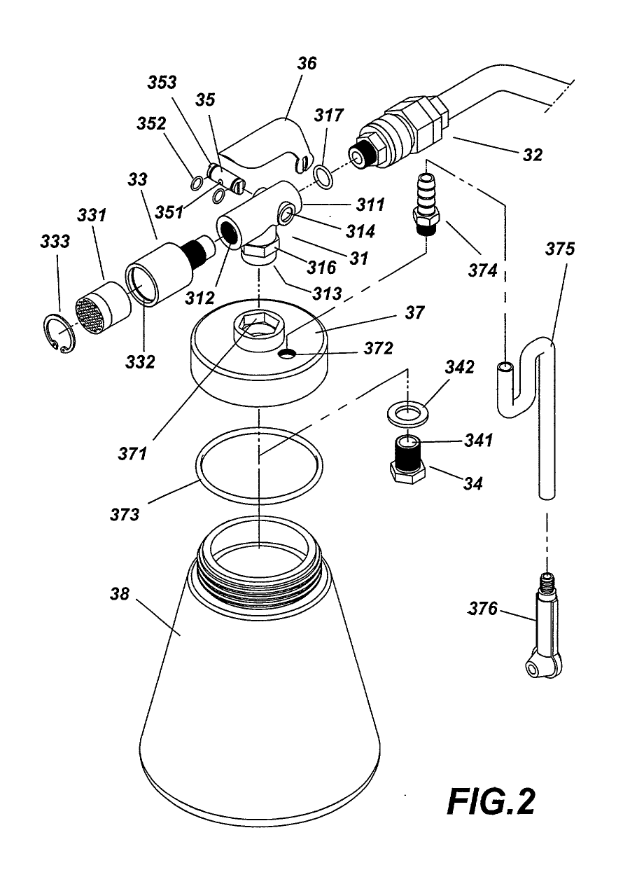

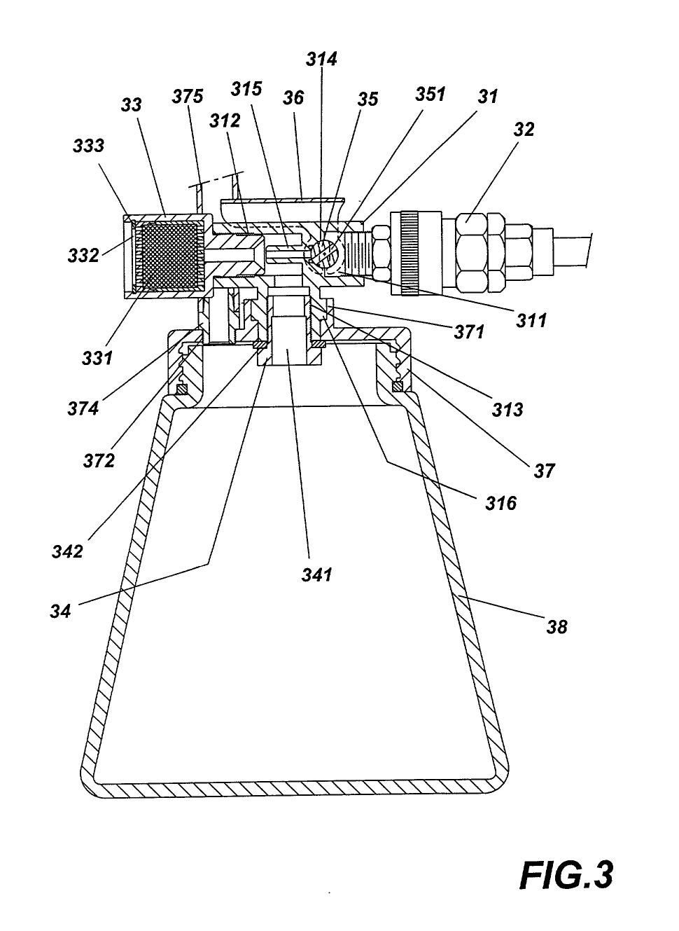

Referring to FIG. 2 and FIG. 3, the present invention is comprised of a three-way T-shaped nozzle carrier 31 having three tap holes 311 312 and 313 for separately securing to a rapid combined connection 32, a muffle seat 33 and a combined fastening bolt 34, in which a radial valve through-hole 314 is built as a valve buckle for a control valve cock 35 fitting in, and said control valve cock 35 has a crossing valve opening 351, and is sealed the both ends by two O-rings separately, and two tenons 353 separately built upon the both ends extended out from the both ends of said nozzle carrier 31 so that a non-home switch handle 36 clips from the both ends by inserting the tenons 353 into the both slots 362 having an elastic opening 363 at the end individually on the catch 352 set on the both sides of said non-home switch handle 36 for spinning together; coordinating to the control valve cock 35, said nozzle carrier 31 has a nozzle 315 with a fine hole extending forward at the inside stretching over said vertical tap hole 313; for preventing the connection portion of said control valve cock 35 and the valve opening 315 from leaking an O-ring 317 is set surround the nose end of said valve opening 314; at the bottom side around the vertical tap hole 313 of said nozzle carrier 31, a polygon connector 316 is built on for joining into a polygon hole 371 built on the top end of the cap 37, and they are fastened by securing the combined fastening bolt 34 with a through-hole 341 and a washer 342 on the vertical tap hole 313, meanwhile said cap 37 can be secured on the top end of a coordinating oil tank 38, and sealed by setting an O-ring 373 between them, and said cap 37 has a tap inlet 372 built on the top surface for securing a pipe connection 374 holding a flex cable 375 in a proper length, and a sucker 376 is fastened on the another end of said cable 375 for stretching into the inside of the gear box; a muffle 331 is held on the inside of said muffle seat 33 by locating a snap ring 333 into a internal ring groove 332.

According to above-mentioned mechanical structure feathers of the present invention, the details of structure functions and advanced progresses will be described in follows:

1. The non-home switch's action—cutting in or off:

as shown in FIG. 3, the non-home switch handle 36 is placed on cut-off state—the crossing valve opening 351 is blocked out without connecting to the nozzle 315, so the control valve cock 35 is in closing state, and is sealed from the both ends and located in any position by the friction forces of the two O-rings 352 and the valve through-hole 314 without any loosing;

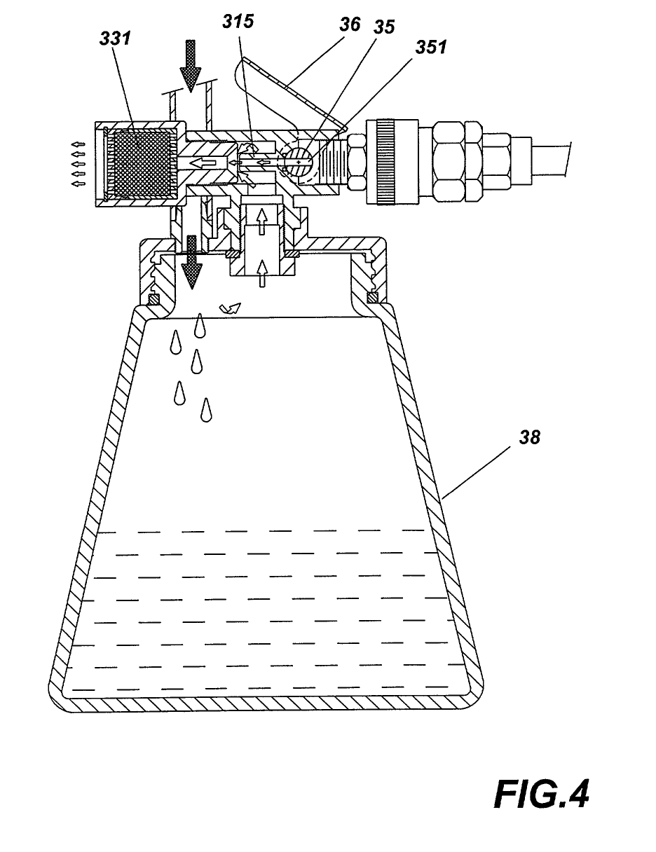

as want to lead in the compressed air, turn the switch handle 36 in clockwise (as shown in FIG. 4) to lug the valve cock 35 to spin an angle until the valve opening 351 aligns to the nozzle 315 so as to make the compressed air jet out from the nozzle 315 to the muffle 331 at the high speed, simultaneously to generate a vacuum suction force in the inside of said oil tank 38 so that the waste oil in the gear box is sucked into the oil tank 38 via the sucker 376, and the air is drained out through said muffle 331 by reducing noise and speed, meanwhile keep a proper suction force in the oil tank to let the oil drop into the bottom of the tank and the air is sucked out from the hollow space of the oil tank 38 to perform oil-air separation function until the oil collection tank 38 is filled up or the waste oil in the gear box is drained away, then the switch handle 36 is pressed down in counterclockwise to stop the suction process;

in the case, the switch handle 36 can be located on any angle whatever in cut-in and cut-off, or any positions between them by the friction force created between the O-rings 352 and the valve buckle 314 so that the operator can control the valve cock 35 cut-in compressed air to carry out suction process or cut off without keeping holding with the switch handle 36 during process, the operator do not need to draw attention on the switch handle 36, but just on adjusting the position in the gear box, therefore the operation becomes more facility and progressive.

2. Suiting to various sized oil container:

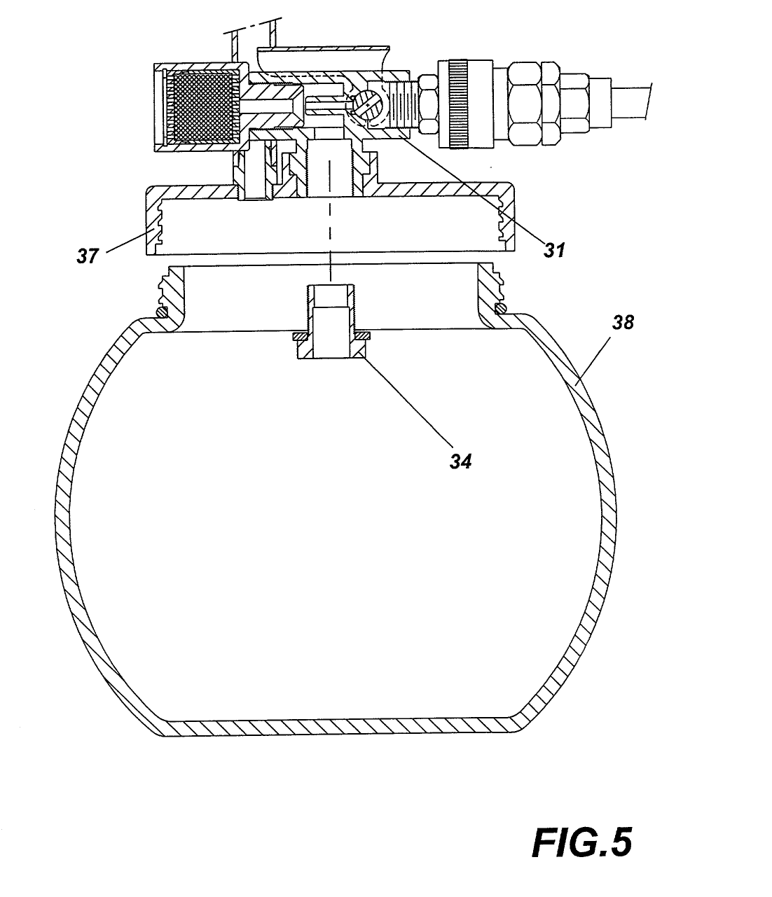

referring to FIG. 2 and FIG. 3, due to applying dividable joint structure between said cap 37 and said nozzle carrier 31, said cap 37 can be replaced with other different sized cap 37 for attaching various volume oil tank 38, as shown in FIG. 5, by screwing off said combined fastening bolt 34 to remove said cap 37 from said nozzle carrier 31, then place on a desired sized cap 37 for joining different size oil tank 38 so as to suit to different gear box containing various volume of oil without needing to buy a new set of oil header having different sucking oil volume, it not only saves money for the users, but also facilitates operation by replacing oil tanks rapidly, and has more practicability and advancement.

Therefore, according to above-described, we can find out the present invention has overcome all the demerits of the conventional airless oil header, for example, as operating do not need to hold down the control handle, which can be located on any position in the present invention so as to make the cut-in or off processes easier and rapider, on the other hand, the dividable joint structure of said cap and the nozzle carrier designed makes change different size oil tanks for suiting to working on different gear box become true and easy and facility, in additional said switch handle and control valve of the present invention are combined into said nozzle carrier directly in design changing the conventional joint structure of the blowgun and the airless nozzle carrier to make the structure simpler and smaller with lower production cost, further to improve the competence in market.

I claim:

1. An airless oil header comprised of a three-way T-shaped nozzle carrier having three tap holes for separately securing to a rapid combined connection, a muffle seat and a combined fastening bolt, in which a radial valve through-hole is built as a valve buckle for a control valve cock fitting in, and said control valve cock has a crossing valve opening, and is sealed the both ends by two O-rings separately, and two tenons separately built upon the both ends extended out from the both ends of said nozzle carrier so that a non-home switch handle clips from the both ends for spinning together; coordinating to the control valve cock, said nozzle carrier has a nozzle with a fine hole extending forward at the inside stretching over said vertical tap hole; for preventing the connection portion of said control valve cock and the valve opening from leaking an O-ring is set surround the nose end of said valve opening; at the bottom side around the vertical tap hole of said nozzle carrier, a polygon connector is built on for joining into a polygon hole built on the top end of the cap, and they are fastened by securing the combined fastening bolt with a through-hole and a washer on the vertical tap hole, meanwhile said cap can be secured on the top end of a coordinating oil tank, and sealed by setting an O-ring between them, and said cap has a tap inlet built on the top surface for securing a pipe connection holding a flex cable in a proper length at the back end, and a sucker is fastened on the another end of said cable for stretching into the inside of the gear box; a muffle is held on the inside of said muffle seat by locating a snap ring into a internal ring groove.

2. An airless oil header as claimed in claim 1, wherein said non-home switch handle has a pair of slots having an elastic opening at the end individually on the catch set on the both sides for catching the tenons of said valve cock into moving together.
